(19) United States
(12) Patent Application Publication
(10) Pub. No.: US 2025/0000030 A1
(43) Pub. Date: Jan. 2, 2025

(54) CHOPPER ASSEMBLY FOR AN AGRICULTURAL HARVESTER

(71) Applicants: CNH Industrial Belgium N.V., Zedelgem (BE); CNH Industrial America LLC, New Holland, PA (US)

(72) Inventors: Stefaan Desmet, Vosselare (BE); Tim Passchyn, SINT-MICHIELS (BE); Cooper Linde, Lancaster, PA (US); Sumit Kumar, New Delhi (IN)

(21) Appl. No.: 18/752,884

(22) Filed: Jun. 25, 2024

(30) Foreign Application Priority Data
Jun. 29, 2023 (EP) 23182296.6

(51) Int. Cl. A01F 29/04; A01F 29/12

(52) U.S. Cl. CPC A01F 29/04; A01F 29/12

(57) ABSTRACT

The chopper assembly includes a rotatable chopper drum having a plurality of knives mounted between two sidewalls and configured to cut larger plant material into smaller particles through the interaction of the knives and a set of counterknives. A guide surface is mounted on at least one of the sidewalls, preferably on both sidewalls, and in the path of a stream of crop material advancing towards the chopper assembly. The guide surface extends between an upstream edge lying essentially in the plane of the sidewall and a downstream edge removed from the sidewall. The guide surface is furthermore inclined relative to the sidewall, so as to guide plant material away from the sidewall and in the direction of the knives located closest to the sidewall. The guide surface thereby prevents plant material from passing between the knives and the sidewall without being cut.

### CROSS-REFERENCE TO RELATED APPLICATION

This application claims priority to European Patent Application No.: 23182296.6, filed Jun. 29, 2023, the content of such application being incorporated by reference herein in its entirety.

### FIELD OF THE INVENTION

The present invention is related to agricultural harvesters, in particular to a residue chopper assembly configured to be located at the rear of the harvester.

### STATE OF THE ART

In a combine harvester, crops like corn or wheat are cut and subsequently processed in order to separate grains from plant residue material. A combine harvester typically comprises a threshing section and a cleaning section, the latter including sieves for separating clean grains from smaller plant residue. The clean grains are collected in a trough at the bottom of the cleaning section, and thereafter transported to a grain tank higher up in the combine's structure.

Residue material, also referred to as material other than grain (MOG) needs to be removed from the harvester. This includes larger plant material such as stalks collected at the end of the threshing section, and smaller material blown towards the rear of the harvester by the cleaning fan. Before being evacuated from the harvester, the larger residue material can be chopped into smaller pieces in a chopper assembly, followed by a spreader which spreads the chopped residue particles in the form of a wide swath of residue material deposited on the field behind the advancing combine.

The chopper assembly usually comprises a rotatable chopper drum comprising knives which move relative to stationary counterknives, to thereby chop the stalks into smaller particles. The drum is mounted transversally with respect to the fore-aft direction of the harvester, so that a stream of residue material is supplied to the chopping drum, with the width of the stream corresponding to the length of the drum. The knives are distributed at regular distances along the longitudinal direction of the drum, to thereby cut the stream of residue material into small particles. The chopper drum and counterknives are mounted between upright sidewalls which guide the stream of plant material towards the drum.

A problem related to presently known chopper assemblies is that due to space constraints and assembly requirements, the knives closest to the sidewalls are necessarily placed at a certain distance from these sidewalls, so that stalks are able to pass through these lateral spaces without being cut.

### SUMMARY OF THE INVENTION

The invention is related to a chopper assembly and to a harvester as described in the appended claims. The chopper assembly comprises a rotatable chopper drum as known from the prior art, comprising a plurality of knives, mounted between two sidewalls and configured to cut larger plant material into smaller particles through the interaction of the knives and a set of counterknives. According to the invention, a guide surface is mounted on at least one of the sidewalls, preferably on both sidewalls, and in the path of a stream of crop material advancing towards the chopper assembly. The guide surface extends between an upstream edge lying essentially in the plane of the sidewall and a downstream edge removed from the sidewall. The guide surface is furthermore inclined relative to the sidewall, so as to guide plant material away from the sidewall and in the direction of the knives located closest to the sidewall. The guide surface thereby prevents plant material from passing between the knives and the sidewall without being cut.

### BRIEF DESCRIPTION OF THE FIGURES

FIG. 1a is a side view illustrating the main components of a combine harvester as known in the prior art, including the location of the chopper assembly and the residue spreader.

FIGS. 1b and 1c illustrate the functioning of the chopper assembly and the spreader.

FIG. 2 is a 3D section view illustrating the position of one of the guide surfaces in a chopper assembly according to an embodiment of the invention.

FIG. 3 is a 2D section view of the chopper assembly of FIG. 2, as seen in the direction of the chopper drum's rotation axis.

FIG. 4a is a frontal view of the chopper drum including the two guide surfaces in a chopper assembly according to an embodiment of the invention.

FIG. 4b is an enlarged detail, showing the position of one of the guide surfaces.

FIG. 5 is a detailed view of the guide surface according to an embodiment of the invention.

FIGS. 6a and 6b illustrate another embodiment of the invention wherein the guide surfaces are located upstream of the inlet opening of the chopper assembly.

### DETAILED DESCRIPTION OF PREFERRED EMBODIMENTS OF THE INVENTION

Preferred embodiments will now be described with reference to the drawings. The detailed description is not limiting the scope of the invention, which is defined only by the appended claims.

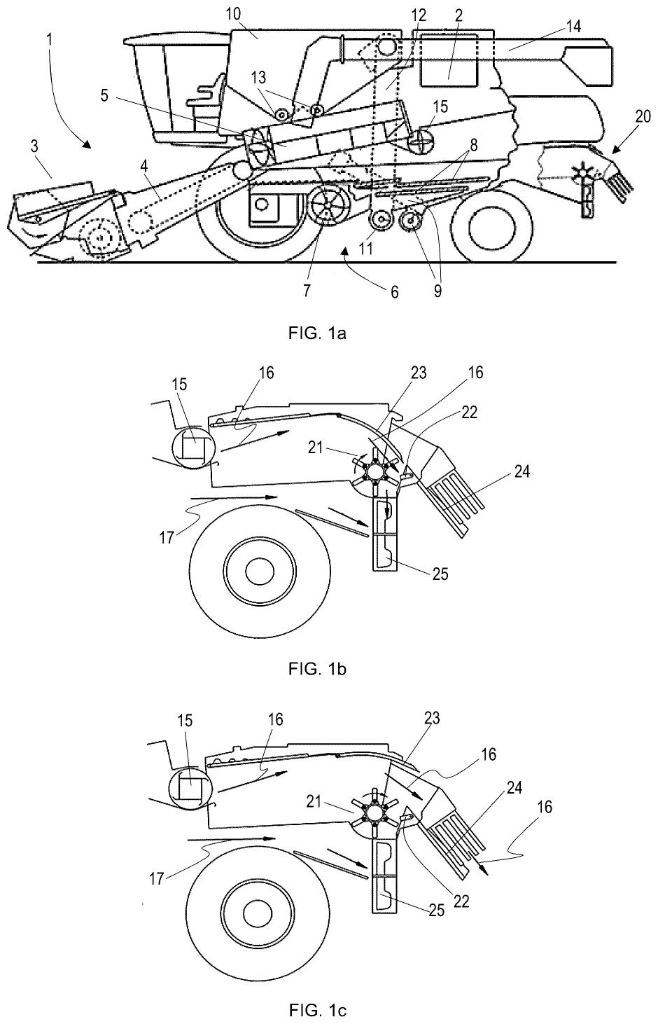

With reference to FIG. 1a, a combine harvester 1 as presently known in the art includes an engine 2, a header 3 for cutting crops from the field, and for gathering the crops towards the inlet of a feeder 4. The feeder delivers the crops to one or two threshing rotors 5 which separate larger plant material from grains and smaller residue. The cleaning section 6 of the harvester includes a blower 7 and a plurality of sieves 8 for separating grains from the smaller residue. Insufficiently separated plant material is transported back to the threshing rotors via return augers 9. Fully separated grains are collected in a grain tank 10 through the combined action of a clean grain auger 11 and a grain elevator 12. From the tank 10, the grains may be evacuated from the harvester through further augers 13 at the bottom of the grain tank and through a pivotable spout 14. Small plant residue, also referred to as chaff, is blown towards the rear of the harvester by the blower 7.

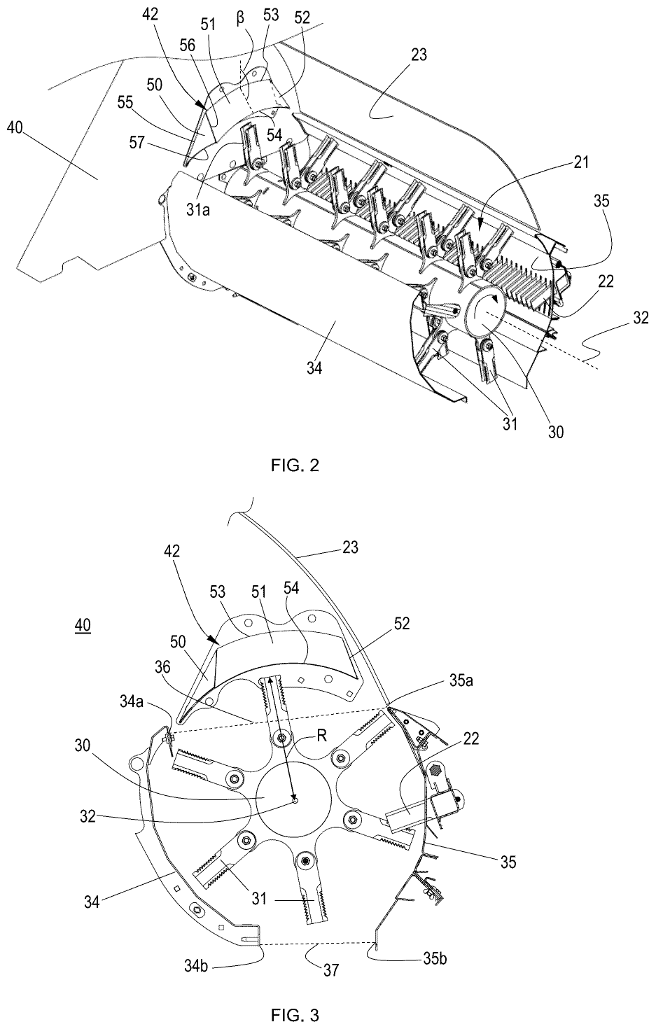

Larger plant residue such as plant stalks and leaves, arrives at the end of the threshing rotors 5 and is subsequently moved to the rear of the harvester by a beater drum 15. A stream of such larger plant material is thereby supplied in the direction of a chopper assembly 20, shown in more detail in FIGS. 1b and 1c. The chopper assembly comprises a chopper drum 21 that is rotatable in the indicated direction relative to a set of counterknives 22. The general direction of the stream of large plant residue is indicated by the arrows 16. A pivotable cover 23 is arranged to direct the stream either towards the chopper drum 20 to be cut into smaller particles (as shown in FIG. 1b) or directly towards an ejection chute 24 without being cut (as shown in FIG. 1c). Downstream of the chopper drum 21, spreader wheels 25 are mounted. The spreader wheels receive a stream of chopped particles from the chopper assembly (when the cover 23 is pivoted downward) and a separate stream 17 of chaff from the cleaning section 6. The spreader wheels 25 spread out the chaff and chopped particles across a wide swath at the rear of the combine.

Whereas FIGS. 1a-1c are intended only to indicate the general location of the chopper assembly in a combine harvester, FIGS. 2 to 4 show various images of an actual chopper assembly in accordance with an embodiment of the invention.

A number of components of the represented embodiment which are known as such will be described first. The chopper drum 21 comprises a cylinder 30 with knives 31 pivotably attached thereto. The knives are arranged in linear rows mounted on the cylinder's surface at regular angular distances between consecutive rows, each row comprising knives mounted at regular linear distances in the longitudinal direction of the cylinder 30. The drum 21 is rotatable about its central rotation axis 32, the rotation being driven by a suitable drive mechanism known as such and therefore not described here in detail. A set of counterknives 22 is mounted so that the chopper knives 31 move in between the counterknives 22 as the drum rotates in the indicated direction, to thereby cut the plant residue into smaller pieces.

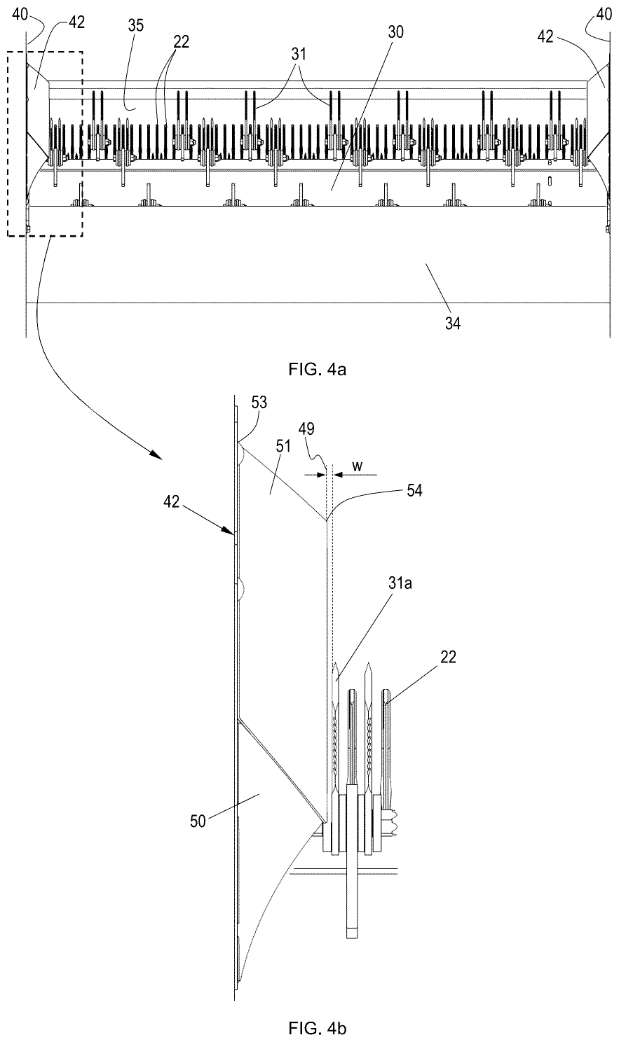

In the front-aft direction of the combine, the chopper drum 21 is mounted between a front concave 34 and a rear concave 35. Each of these concaves extends between an inlet edge (34a,34b) and an outlet edge (35a,35b). These edges respectively define an inlet opening 36 between inlet edges 34a and 35a and an outlet opening 37 between outlet edges 34b and 35b. With the pivotable cover 23 in the downward position as shown in FIGS. 2 and 3, the path of the plant material coming from the threshing rotors passes through the inlet opening 36, and a stream of chopped particles is ejected through the outlet opening 37. In the transversal direction, and as best visible in FIG. 4a, the drum 21 is rotatably mounted between upright sidewalls 40.

In accordance with the invention, the chopper assembly comprises guide surfaces 42 on the respective sidewalls 40. The main portion 51 (see FIGS. 2 and 3) of these surfaces 42 is oriented at an obtuse angle β relative to the respective sidewalls. The guide surfaces 42 extend between an upstream edge 53,55 lying essentially in the plane of the sidewalls 40 and a downstream edge 54,57 removed from the sidewalls in the longitudinal direction of the chopper drum 21. The guide surfaces 42 are thus inclined relative to the sidewalls 40 in such a manner as to guide plant material away from the sidewalls and in the direction of the outer knives 31a of the drum, i.e. the knives which are located closest to the sidewalls, thereby ensuring that essentially no plant stalks or other large plant material passes through the gap between these outer knives 31a and the sidewalls 40 without being cut.

FIGS. 2 and 3 illustrate the shape of the guide surfaces 42 according to one embodiment of the invention. This particular shape is however just one example of a suitable shape, and other examples will be described later in this text. A common characteristic to all embodiments of the invention is that the guide surfaces force plant material at the sides of the incoming stream to be deflected towards the knives of the chopper drum 21.

FIGS. 2 and 3 show one guide surface 42 mounted on one of the sidewalls 40. The other guide surface on the opposite sidewall is the mirror image of the illustrated guide surface 42. The invention is however not limited to embodiments wherein the guide surfaces are identical and mirrored. Although the latter represents an option that may be preferable in most harvester configurations, in some configurations it could be advantageous to provide guide surfaces on the two sidewalls which differ from each other in terms of their shapes and dimensions. Also, the invention includes embodiments wherein a guide surface is only present on one side of the chopper drum, on one of the sidewalls 40, while no guide surface is mounted on the opposite sidewall. This may be appropriate in cases were the gap between the knives and one of the sidewalls is smaller on one side than on the opposite side for example.

As seen in the drawings, the guide surface 42 in the illustrated embodiment is part of a welded piece that is bolted to the side wall 40. The guide surface is thereby removably attached to the sidewall. According to other embodiments however, the guide surface may be permanently attached or uniform with the sidewall.

In any embodiment of the invention, the guide surface is mounted in the path of the incoming crop stream. In the embodiment shown in FIGS. 2 and 3, the guide surface 42 is located across the inlet opening 36, i.e. along one lateral side of said inlet opening. Other locations of the guide surface are possible, as will be illustrated later.

In the embodiment shown, the welded piece comprises plate elements whose outer surfaces define the guide surface 42, which comprises a triangular side portion 50 and a conical main portion 51. A triangular plate element 52 is located on the opposite side of the first triangular portion 50. The outer surface of this latter plate element 52 is more or less perpendicular to the sidewall 40 and is therefore not a part of the guide surface as such.

The conical portion 51 extends between a first curved edge 53 and a second curved edge 54. The first curved edge 53 is essentially in the plane of the sidewall 40. As best seen in FIG. 4b, the second curved edge 54 is located in an end plane 49 that is perpendicular to the drum's rotation axis 32 and adjacent to the knives 31a located closest to the sidewall 40, with a small gap w remaining between said end plane 49 and the knives 31a. According to the embodiment shown in the drawing, the gap w is situated on the far side of the knives 31a, as seen from the middle of the drum cylinder 30. In other words, the width of the guide surface 42 (as measured in the direction of the drum's rotation axis 32) almost fills the distance between the knives 31a and the sidewalls 40 but does not overlap with said knives 31a (i.e. the knives closest to the sidewalls). A small overlap with said closest knives 31a may nevertheless be allowed, although it cannot be so big as to obstruct the cutting function of the knives 31a.

As seen in the side view regarded along the drum's rotation axis 32 in FIG. 3, the second curved edge 54 does not overlap the knives 31 when the knives are oriented radially with respect to the cylinder, i.e. when the drum is rotating at a sufficient speed so that the knives are forced into this radial position along radius R by the centrifugal force. Although this latter feature (guide surface does not overlap the knives in the side view) is not a limiting feature of the invention, it is nevertheless preferred in order to avoid plant material becoming stuck between the outer knives 31a and the guide surface 42.

The first triangular side portion 50 extends between a straight edge 55 essentially in the plane of the sidewall 40, a lateral edge 56 of the conical portion 51, and a curved lower edge 57. This inclined triangular portion 50 optimizes the guidance of crops at one side of the inlet gap. The invention is however not limited to guide surfaces comprising this triangular side portion 50.

The triangular plate element 52 closes off the conical portion 51 on the side opposite the side at which the first triangular portion 50 is located. As stated, the surface of the plate element 52 is not to be regarded as part of the guide surface 42 as such.

The guide surface 42 in the case of the illustrated embodiment is therefore formed by the combined portions 50 and 51. The upstream edge is formed by the combined edges 55 and 53. The downstream edge is formed by the combined edges 57 and 54.

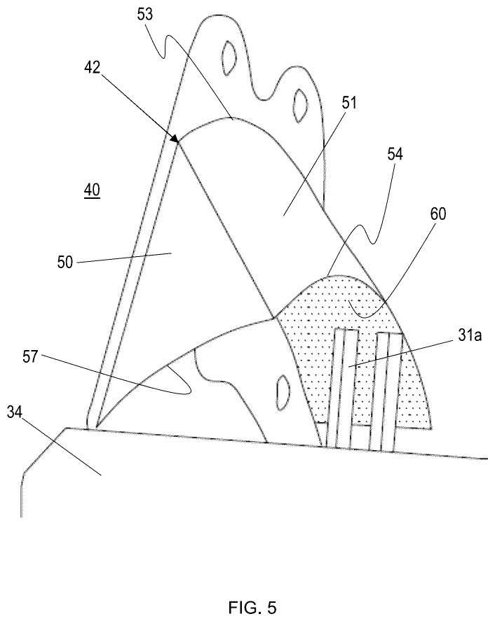

Another element that is optional is illustrated in the detail image in FIG. 5. It is seen that a cylindrical bottom plate element 60 blocks the entry of plant material into the space between the sidewall 40 and the downstream edge 54,57. This cylindrical plate element 60 thereby prevents crops from accumulating in this space.

As stated above, the invention is not limited to the specific shape of the guide surfaces shown in FIGS. 2-4. The surfaces could have more rudimental shapes, as long as they are suitable for guiding the crops away from the sidewalls and towards the knives 31a closest to the sidewalls. In stead of having a conical shape for example, the guide surfaces could be flat surfaces oriented at a suitable obtuse angle in the direction of the knives. On the other hand, the shape may be more intricate than illustrated, for example comprising several portions oriented at one or more different obtuse angles relative to the sidewall.

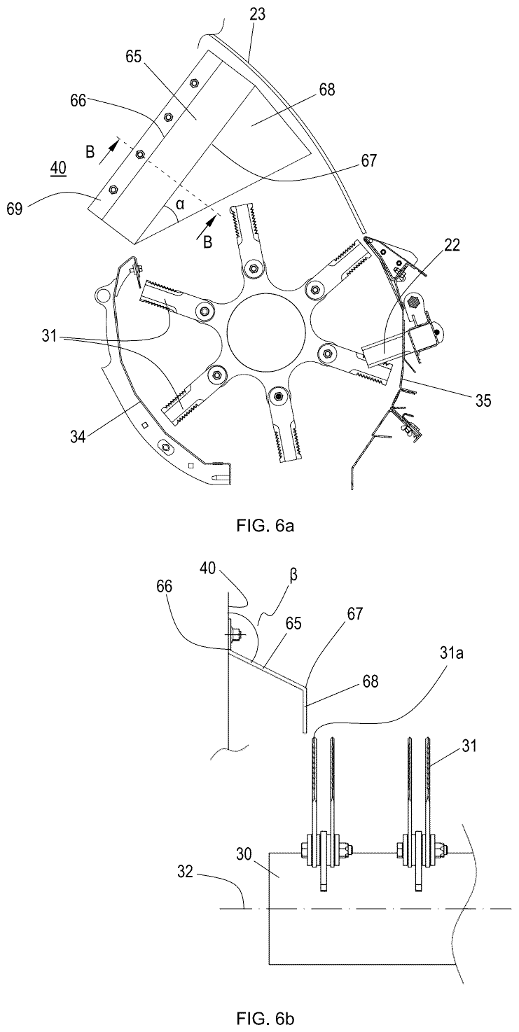

According to another embodiment, the guide surfaces are not placed directly in the inlet opening 36 but more upstream in the path of the plant material. Such an embodiment is illustrated in FIG. 6. The guide surface 65 is a straight inclined surface placed at an angle α to the inlet opening 36 and inclined at an obtuse angle with respect to the sidewall 40. The guide surface 65 in this embodiment is a plate element that is uniform with a strip 69 bolted to the sidewall 40. The guide surface 65 extends between an upstream edge 66 and a downstream edge 67. In addition, a guide plate 68 is attached to the downstream edge 67. The guide plate 68 is oriented perpendicularly to the drum's rotation axis 32 and located adjacent and in close proximity to the outer knives 31a. After being deflected from the sidewall by the guide surface 65, plant material is guided along the guide plate 68 towards the knives. Like the embodiment of FIGS. 2 to 4, the effect is also that plant material is inhibited from passing between the sidewalls and the knives without being cut. Instead of the straight guide surface 65, more intricate shapes of the guide surfaces can be applied in this embodiment, i.e. placed upstream of the inlet opening and combined with a guide plate 68.

It is understood therefore that various embodiments not described here explicitly are within the scope of the appended claims.

What is claimed is:

1. A chopper assembly for an agricultural harvester, the chopper assembly comprising:
a chopper drum comprising a plurality of chopper knives arranged along the longitudinal direction of the drum, wherein the chopper drum is rotatable about a longitudinal rotation axis,
a set of counterknives,
a pair of sidewalls oriented transversely with respect to the longitudinal rotation axis of the chopper drum, the chopper drum being rotatably mounted between said sidewalls,
an inlet opening and an outlet opening, each opening comprising a first and second lateral side arranged along the respective sidewalls,
at least one guide surface mounted on at least one of the sidewalls, wherein said at least one guide surface extends between an upstream edge lying substantially in a plane of said at least one of the sidewalls and a downstream edge removed from said at least one of the sidewalls, and wherein said at least one guide surface is inclined relative to said at least one of the sidewalls so as to guide plant material away from said at least one of the sidewalls and in a direction of the chopper knives located closest to said at least one of the sidewalls,
wherein the chopper assembly is configured to:
(i) receive through said inlet opening a stream of the plant material advancing between the sidewalls,
(ii) cut the plant material into particles, and
(iii) eject the particles through the outlet opening.

2. The chopper assembly according to claim 1, wherein at least a portion of the downstream edge of the guide surface lies in an end plane that is oriented substantially perpendicular to the rotation axis of the chopper drum.

3. The chopper assembly according to claim 2, wherein said end plane is located in close proximity to said knives located closest to said at least one of the sidewalls, whilst lying on a far side of said knives as seen from a middle of the chopper drum.

4. The chopper assembly according to claim 2, wherein the guide surface comprises or consists of a conical surface portion extending between curved portions of said upstream and downstream edges.

5. The chopper assembly according to claim 4, wherein the curved portion of the downstream edge does not overlap the knives, as seen in a side view along the rotation axis of the chopper drum, when the chopper drum is rotating.

6. The chopper assembly according to claim 1, wherein the guide surface comprises one or more portions oriented at one or more different obtuse angles (B) to said at least one of the sidewalls.

7. The chopper assembly according to claim 6, wherein the guide surface comprises a conical portion and a triangular portion that is disposed to one lateral side of the conical portion.

8. The chopper assembly according to claim 1, wherein the guide surface is located across the inlet opening at a lateral side thereof.

9. The chopper assembly according to claim 1, wherein the guide surface is located upstream of a lateral side of the inlet opening.

10. The chopper assembly according to claim 9, further comprising a guide plate (i) attached to the downstream edge of the guide surface, (ii) oriented substantially perpendicular to the rotation axis of the chopper drum, and (iii) configured to guide plant material from the downstream edge of the guide surface in the direction of the knives closest to said at least one of the sidewalls.

11. The chopper assembly according to claim 1, wherein the guide surface constitutes a separate component that is removably attached to said at least one of the sidewalls.

12. The chopper assembly according to claim 1, wherein the guide surface comprises at least one plate element oriented at an obtuse angle from said at least one of the sidewalls, so that an open space is created between said plate element and said at least one of the sidewalls, and wherein an additional plate element is mounted between the downstream edge and said at least one of the sidewalls, so as to block entry of plant material into said open space in a direction perpendicular to the upstream edge.

13. The chopper assembly according to claim 1 further comprising a first and second concave with the chopper drum mounted between said concaves, wherein both concaves comprise an inlet edge and an outlet edge, so that said inlet opening is formed between the inlet edges and said outlet opening is formed between the outlet edges.

14. The chopper assembly according to claim 1, wherein said guide surfaces are mounted on respective sidewalls, said guide surfaces being identical in shape and dimensions but mirrored relative to each other with respect to a plane perpendicular to the rotation axis of the chopper drum.

15. An agricultural harvester comprising the chopper assembly in accordance with claim 1.
